(19) United States
(12) Patent Application Publication
(10) Pub. No.: US 2012/0097167 A1
(43) Pub. Date: Apr. 26, 2012

(54) MASK WITH NOSAL CUSHION

(76) Inventors: Kenichi Ono, Saitama (JP); Shuichiro Shimada, Saitama (JP); Yusuke Takayama, Saitama (JP)

(21) Appl. No.: 13/376,520

(22) PCT Filed: Sep. 30, 2009
(86) PCT No.: PCT/JP09/67446

§ 371 Date: Dec. 6, 2011

(30) Foreign Application Priority Data
Jun. 12, 2009 (JP) 2009-141257

(51) Int. Cl. A62B 18/08

(52) U.S. Cl. 128/206.14

(57) ABSTRACT

Provided is a mask with a nosal cushion, the mask consisting of a filter that filters dust, wherein, the edges of the filter are folded back to create flaps that follow the depressions on both sides of the nosal region. A sponge of urethane foam or the like is affixed inside the flaps, thereby improving the fit of the mask by conforming the mask to the contours of the nosal region, resulting in a mask cushion with a nosal cushion that has cushioning properties and strong protective capabilities.

### FIELD OF THE INVENTION

The present invention relates to a mask used for medical use, food hygience use, ordinary industrial use, pollenosis protector use, infection prevention use or sanitary use in common life, specifically, the present invention relates to a mask whose adhesion to nosal region, where is difficult part for adhering the mask perfectly to face of a user, is improved.

### DESCRIPTION OF PRIOR ARTS

A mask can be mainly classified to following two three types. That is, a type to be used in a food factory or a precision factory where cleanliness is required, a type used for sanitary purpose in medical field or in daily life and a type to be for works in an environment contaminated with a lot of airborne particles.

The mask of the present invention is used in these mentioned fields, and mask main body is composed of sheet shape filter e.g. gauze or non woven cloth, and said filter covers nose, mouth and jaw of a human. And the mask is worn by holding a fastening string at head of the human. Because the shapes of human's head are various, many investigations have been made to fit a mask to shapes of human's head.

Especially, since it is very difficult to fit the mask to undulations of nosal region, sufficient fitness cannot be obtained. As an improved method, in Patent Document 1, a mask characterized that metal parts such as soft aluminum alloy are stuck to sheet shape filter is disclosed. Especially, at nosal region which has large undulations, a user of the mask can bend said metal parts so as to fit the mask to the shape of nosal region of individual users. However, in a case of said mask, each user have to bend the metal part by himself or by herself so as to fit the mask to the shape of face (shape of nosal part), and said bending process is not so easy. When bending is loose, the mask does not fit to the face, while when bending is too much, the mask does not fit to the face too. Further, this mask is used as a cheap mask such as disposal dustproof mask or other simple mask, and because metal part is used, it is necessary to remove this metal part when the used mask is thrown away. This is recognized as a troublesome problem.

Recently, a mask which uses a flexible shape supporting device made of polyolefin synthetic resin which provides a shape supporting function instead of metal (Patent Document 2) is proposed, however, this mask has problems that the shape supporting device is an expensive material and holding power of the mask looses along with lapse of time.

Further, for the purpose to improve adhesion of a mask to nosal part, if holding down power of above mentioned metal parts is made strong, sometimes, aching is caused at nosal part. In said case, following countermeasure is carried out, that is, to stick sponge such as urethane foam at the position of the mask faced to nosal part on the metal parts aiming to improve cushion feature of nosal part and adhesion. However, among sponges such as urethane foam, since cheaper ones has good gas permeability, there is possibility that dusts pass through section of sponge and enter into the mask, further, a problem that exhalation with high humidity passes through the mask and the exhalation makes surface of a glass cloudy. In the meanwhile, a foam of independent pore which has poor gas permeability is expensive.

Furthermore, a method to improve adhesion of a mask by turning over outer periphery of a filter nearby nosal part to the side which adheres with the face (Patent Document 3), or a method to stick other filter to reverse side of a mask (Patent Document 4, 5) are proposed, however, sufficient repulsive power to maintain good adhesion cannot be obtained.

### PRIOR ARTS

### Patent Documents

Patent Document 1: JP2006-305279 publication

Patent Document 2: JP2006-43227 publication

Patent Document 3: JP2009-11709 publication

Patent Document 4: JP2007-54270 publication

Patent Document 5: JP2007-44140 publication

### BRIEF SUMMARY OF THE INVENTION

### Object of the Invention

The present invention relates to a mask which improves above mentioned defects. The object of the present invention is to provide a mask having a structural feature of high cushion property and excellent dustproof property.

### BRIEF ILLUSTRATION OF THE INVENTION

The essential point of the present invention is illustrated as follows. That is, in a mask constructed by a filter which catches dusts and a fastening string which fastens the mask to a face, a flap is provided by turning down upper periphery of the filter and a sponge is stuck in inside of the flap so as the mask to adhere to concave part of both sides of nose.

### EFFECT OF THE INVENTION

The mask of the present invention is providing filter flaps along with concave region besides both sides of nosal part, and by sticking sponge in inside of the flaps, cushion feature is provided to the filter flaps and adhesion of the mask to nosal region can be improved.

### BRIEF ILLUSTRATION OF DRAWINGS

FIG. 1 is a plan view of reverse surface of the mask of this invention

FIG. 2 is an upper plan view of the mask shown in FIG. 1

FIG. 3 is a cross sectional view of flap parts of the mask shown in FIG. 1

FIG. 4 is an illustrating view showing the wearing state of the mask shown in FIG. 1

### PREFERRED EMBODIMENT OF THE INVENTION

The present invention will be illustrated in detail.

The mask of the present invention can be applied as a sanitary mask or a dustproof mask, and as a filter which constructs the mask, unwoven cloth or gauze can be used, however, not intending to be limited to these materials. Further as a sponge to be used in the present invention, rubber sponge, urethane foam or other sponges can be used. And, as a sponge, sponge of independent pores or a sponge of continuous pores can be used, however, since in the mask of the present invention the sponge is not located at the position where air flows, it is preferable to use a cheap sponge having gas permeability.

Regarding shape of the mask, there is no restriction, and any shape of mask composing of mask main body which covers nose, mouth and jaw region and fastening strings attached to both side peripheries of the mask main body can be usable. However, specifically, if the mask of the present invention is applied to the mask disclosed in JPA 2009-059307 which was filed by the present applicant, it becomes possible to provide a disposable mask which can be folded small and adhered perfectly to face of a user, and is desirable.

A mask disclosed in said JPA 2009-059307 is a mask which adjusts center line of the mask main body with a line of nosal crest of a face, and a rectangular center part filter, which is extending to right and left directions, and triangle shape filters set up at upper and lower side of said filter are constructed together with in an integrated manner. Therefore, the mask of the present invention is characterized to provide a flap on reverse side of the mask at the position corresponding to concave part of nosal region, and inside of the flap a sponge such as urethane foam is inserted. By inserting said sponge in the flap, good repulsive elasticity is generated, accordingly adequate pressure is added to the nosal part and it becomes possible to maintain high adhesion, further according to elasticity of sponge, a user of the mask does not feel pain caused by wearing the mask. Still further, since the sponge is covered by a filter which catches dusts, there is no leak from cross sectional direction of the sponge.

The present invention will be illustrated specifically by Examples, however, not intending to be limited to the Examples.

### EXAMPLES

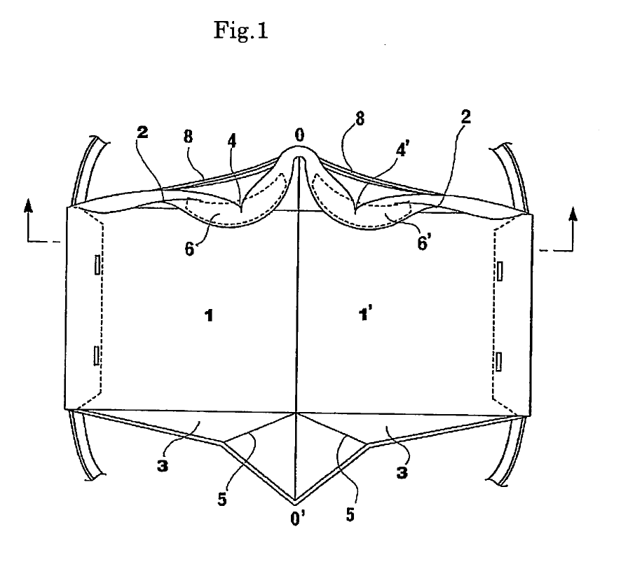

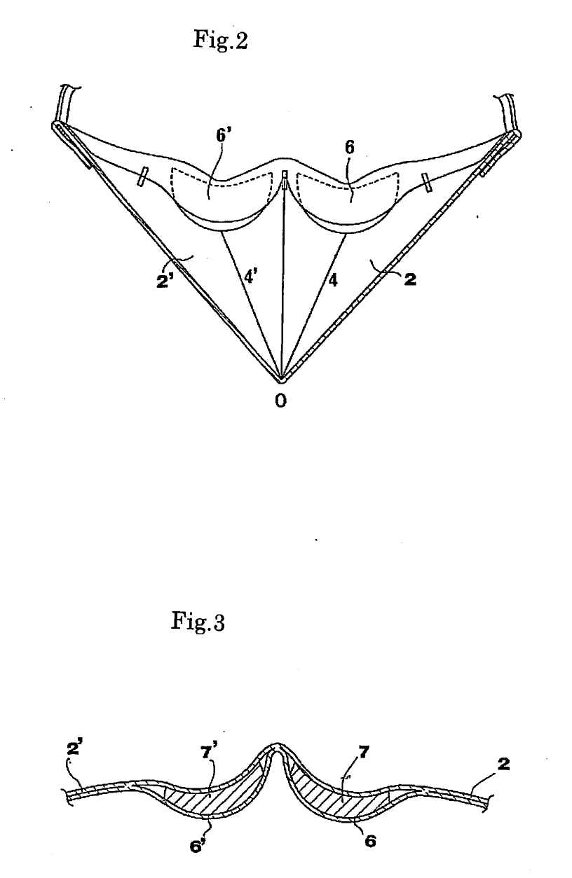

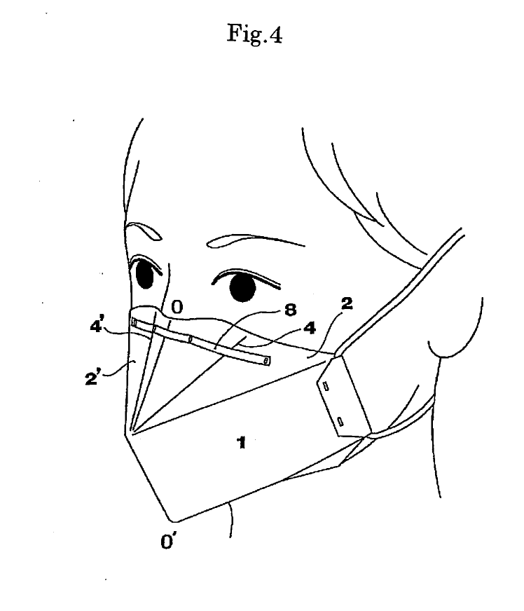

FIG. 1 is a reverse elevation of the mask of the present invention. This mask has rectangular filter 1 and 1′ at the center part which is symmetry at right and left side against center line OO′, and triangle shape filter 2 and 2′ are provided at upper part of the rectangular, and triangle shape filter 3 and 3′ are provided at lower part of the rectangular, in an integrated manner, thus the mask main body is constructs. A fastening string is installed to left and right outermost periphery of mask main body by turning down the outermost peripheries. Further, beams 4 and 4′ which are bound by e.g. ultra sonic welder are provided to the upper triangle shape filter, and in the same way, beams 5 and 5′ are provided to the lower triangle shape filter. These beams are provided so as to maintain three dimensional shape of the mask and to endow foldable feature of the mask. And, in the present invention, flaps 6 and 6′ are provided by turning down the nosal region of the mask to reverse side of the mask which adheres with face of a user, and in inside of said flaps, sponges 7 and 7′ are packed with. As a method to pack with sponge in the flap, a method to turn down the position where the sponge is stuck and bind right and left sides of the sponge by an ultra sonic welding method, or a method to stick the sponge to the turned down surface of the flap can be mentioned. Furthermore, it is desirable to connect upper triangle shape filters of right and left side by a rubber string so as to maintain three dimensional shape of the mask.

In the present invention, by packing with sponge into inside of the flap, repulsive elasticity is generated, accordingly adequate pressure is added to the nosal part and it becomes possible to maintain high adhesion. And since the sponge is covered by a filter which catches dusts, there is no leak from cross sectional direction of the sponge.

### INDUSTRIAL APPLICABILITY

The present invention can provide a mask which has excellent adhesion to the face of the user, because, flaps are provided along with concave region besides both side of nosal part and a sponge such as urethane foam is stuck in inside of the flaps.

### ILLUSTRATION OF MARKS

1, 1′: center filter
2, 2′: upper triangle shape filter
3, 3′: lower triangle shape filter
4, 4′ 5, 5′: beam
6, 6′: flap
7, 7′: sponge
8: rubber string
OO′: center line

1. A mask comprising, a mask main body containing a filter which filtrates dusts and a fastening string to be used for wearing the mask, said mask main body has structural feature that the center line of the mask main body is adjusted with nosal crest line of a user, and a rectangular center part filter, which is extending to right and left direction, and triangle shape filters set up at upper and lower side of major sides of said rectangular filter are constructed together with in an integrated manner, wherein a flap is prepared by turning down upper periphery of said filter, and a sponge is stuck in inside of said flap so as to adhere the mask to concave regions of both sides of nose.

2. (canceled)

3. The mask of claim 1, wherein upper triangle shape filters of right and left side are connected by a rubber string.

4. The mask of claim 1, wherein beams bound by ultra sonic welder for folding are provided to the upper and bottom triangle shape filter of right and left side.
